(19) United States
(12) Patent Application Publication
(10) Pub. No.: US 2026/0054742 A1
(43) Pub. Date: Feb. 26, 2026

(54) METHOD FOR CONTROLLING AN AT LEAST PARTIALLY ASSISTED DRIVING VEHICLE

(71) Applicant: MAGNA Automotive Europe GmbH, Wien (AT)

(72) Inventors: Matthias DORFER, Neuhofen a.d. Krems (AT); Martin GROSSBICHLER, Aschbach/Steyr (AT); Christoph HOEFER, Hargelsberg (AT); Pavlo TKACHENKO, Linz (AT)

(21) Appl. No.: 19/263,756

(22) Filed: Jul. 9, 2025

(30) Foreign Application Priority Data
Aug. 22, 2024 (EP) EP24195815.6

(51) Int. Cl. B60W 50/10

(52) U.S. Cl. CPC B60W 50/10; B60W 2552/15; B60W 2552/20; B60W 2555/20; B60W 2555/60

(57) ABSTRACT

A method for controlling a vehicle that is at least partially assisted via an ADAS control system. A planner module performs numerical optimization to achieve goals such as a short travel time and low energy consumption. The numerical optimization uses context information as input parameters, such context information including route information, road course information, and/or environmental information. An output of the planner module is used as an input parameter for the ADAS control system for operating the vehicle. A personalized driver parameter set for corresponding to a specific driver is used as a boundary condition for the numerical optimization. The personalized driver parameter set represents a personal driving style of the specific driver.

### CROSS-REFERENCE TO RELATED APPLICATIONS

The present disclosure claims priority under 35 U.S.C. § 119 to European Patent Publication No. EP 24195815.6 (filed on Aug. 22, 2024), which is hereby incorporated by reference in its complete entirety.

### TECHNICAL FIELD

The present disclosure relates to a method, such as, for example, a computer-implemented method for controlling a vehicle that is at least partially assisted and a control unit for a vehicle that is at least partially assisted.

### BACKGROUND

At least partially assisted vehicles are also known as ADAS vehicles (Advanced Driving Assistant Systems) or automated vehicles. In such vehicles, an assistance system of the motor vehicle can, for example, intervene in the lateral control and/or in the longitudinal control of the motor vehicle. These vehicles also include fully automated or autonomous motor vehicles, in which control of the motor vehicle can be carried out fully autonomously.

In addition to or as an alternative to control by a driver, the control of such vehicles is carried out by an ADAS control system, which determines suitable travel trajectories in the longitudinal and/or lateral direction and thus suitable acceleration and/or steering processes in order to achieve specified driving goals while complying with conditions such as avoiding collisions with other road users.

Personalization of such an ADAS control system is only known insofar as such vehicles can have a number of predefined driving modes that the driver can select and set manually. With such a mechanism, the vehicle gives the driver a way to influence the behaviour of the automated driving functions (e.g., ADAS).

The human driver, however, must first develop an intuition for the available configuration options, namely driving modes. This is a slow, iterative process (trial and error) to achieve the desired driver experience.

In addition, the limited number of options currently available may not cover the driver's personal preferences, meaning the underlying personalization model to achieve a desired driver experience is technically very limited.

A technical challenge is also the consideration of the context—in these fixed driving modes, i.e., the specific features of the current and also near future driving situation and the vehicle environment.

Contextual consideration in today's ADAS systems is static and limited to a few signals, so modes cannot automatically adapt to the latest information while driving. Usually, there is no forward-looking planning of an upcoming journey taking into account broader context information such as curves ahead, gradients, road conditions, traffic, and time of day. ADAS systems are not designed to optimize time efficiency or energy efficiency and are limited in their personalisation ability.

### SUMMARY

It is an object of the present disclosure to enhance a computer-implemented method for controlling a vehicle driving at least partially assisted in this respect and, in particular, to specify a computer-implemented method that enables a forward-looking consideration of optimization goals and thereby a high degree of personalization.

A further object of the present disclosure is to specify a control unit for an at least partially assisted vehicle that enables such anticipatory and personalized driving.

The objects are achieved by a computer-implemented method for controlling a vehicle that is at least partially assisted, the computer-implemented method using a planner module that is set up to perform numerical optimization to achieve goals such as a short travel time and/or low energy consumption. Context information, such as route information, road course information and/or environmental information, is used as input parameters of the optimization. An output of the planner module is used as an input parameter for an ADAS control system for the real movement of the vehicle. A personalized driver parameter set for a specific driver is used as a boundary condition of the optimization in the planner module, the personalized driver parameter set representing the personal driving style of the particular driver.

In accordance with the present disclosure, a control method for an at least partially assisted vehicle is specified, which takes into account context information for the achievement of long-term goals, such as a short travel time and/or low energy consumption, via an optimization in a planner module of the control system. This planner module is also designed in such a way that, in addition to achieving the aforementioned goals, additional boundary conditions can be taken into account in the form of a mathematical driver model, which is parameterized by the customizable driver parameter set.

In accordance with the present disclosure, the personalized driver parameter set represents the personal driving style of the specific driver. The representation can be carried out by a mathematical model that includes several parameters. The driver parameter set can be a driver parameter set for a model of driver comfort conditions.

Thus, a system for ADAS personalization is specified that contains the mathematical abstraction of boundary conditions for a driver preference, in particular for the desired comfort of the driver, which is used in a planning module to determine a predictive plan of the trip for a given context and taking into account additional optimization goals, such as energy and time.

The present disclosure thus includes the possibility that the planner can be continuously adjusted and adapted by a user-data-driven learning module and/or by a context-aware online algorithm.

Thus, a driver preference model can be used as a boundary condition for an ADAS planner and learning-based personalization. The planning module can be set up to determine a predictive itinerary for a given context, taking into account optimization goals, such as energy and/or time, and limitations or constraints related to a particular driver's desired driver comfort. The driver's wishes, in particular the desired driver comfort, are not only selected from a class of a few predefined options (such as driving modes), but an individual representation of the driving style of a particular driver is formed in a mathematical model, parameterized by the driver parameter set.

A user-data-driven learning module can be used to derive the personalized parameterization of the planning module. Context-dependent continuous online updating of the planner parameterization can be carried out.

The optimization problem of the planner module is preferably defined discretely. Time and energy can be used as “costs” in the optimization.

A solution according to the present disclosure may include the combination of a model-based method for controlling an at least partially assisted driving vehicle with a data-based machine learning approach to reduce the manual calibration effort while increasing the quality of personalization. The learning module is data-based and open to future extensions to a broader context than the one used today, for example by including future ADAS capture systems.

The personal driving style of the specific driver is preferably represented by lateral and longitudinal acceleration limits in the personalized driver parameter set of the specific driver. Particularly preferably, the driver parameter set describes an at least two-dimensional field of lateral and longitudinal acceleration limits of the specific driver.

Preferably, the personalized driver parameter set is determined by model adaptation or by learning from a pre-recorded set of driving data, in which at least one trip of the particular driver has been recorded.

Preferably, the personalized driver parameter set for the driver comfort conditions model is determined from the prerecorded set of driving data by model adaptation via an optimization method calculating for different driver parameter sets how close a set of driving data calculated from these driver parameter sets is to the recorded set of driving data. In a user data driven learning module, the personalized driver parameter set can be determined by machine learning or artificial intelligence from a recorded set of driving data in which at least one trip by a given driver has been recorded.

In accordance with one embodiment, the personalized driver parameter set is determined from the prerecorded set of driving data by learning in that in a first step the planner module is used to produce a training dataset for different routes, with different context information and different models of personalized driver parameter sets, and that by training a planner inversion model in a second step to determine the underlying personalized driver parameter sets from the training dataset, and that in a third step, the planner inversion model is used to determine the underlying personalized driver parameter set from the pre-recorded set of driving data.

In a realization in accordance with the present disclosure, the determination of the driver parameter set from a recorded set of driving data can thus be done in three steps. In the first step a training dataset is created offline, wherein the planner module is used to create a dataset of planning results for different routes, context information, and driver parameters. In the second step, a planner inversion model is trained offline, which projects from the context and planning result onto the corresponding driver parameter set. This can be carried out by machine learning or artificial intelligence. In the third step, this planner inversion model is applied online to the current set of driving data while driving to determine the corresponding appropriate driver parameter set. This online adapted driver parameter set allows the planner module in the ADAS function to enable a personalized driving style in the assisted or autonomous mode.

Preferably, the context information used as input parameters of the optimization includes: route information, road course information, such as curves, slopes, speed limits, traffic signs, and/or environmental information, such as weather information, temperature information, road condition information, traffic information, and/or sensor information, such as information about vehicles in the vicinity and road conditions in the vicinity.

The object of the present disclosure is also achieved by a control unit for a vehicle that is at least partially assisted, wherein the control unit is designed to carry out a computer-implemented method as described above.

Developments of the present disclosure are indicated in the claims, the description, and the accompanying drawings.

### DRAWINGS

The present disclosure will be described by way of example below with reference to the drawings.

FIG. 1 is a schematic representation of a computer-implemented method in accordance with the present disclosure.

FIG. 2 is a schematic representation of driver conditions for a computer-implemented method in accordance with the present disclosure, with a first context and driver parameter set.

FIG. 3 is a schematic representation of driver conditions for a computer-implemented method in accordance with the present disclosure, with a second context and driver parameter set.

FIG. 4 is a schematic representation of a first computer-implemented method for determining the personalized driver parameter set (D) from a pre-recorded set of driving data (RD), in accordance with the present disclosure.

FIG. 5 is a schematic representation of a first step of a second computer-implemented method for determining the personalized driver parameter set (D) from a pre-recorded set of driving data (RD).

FIG. 6 is a schematic representation of a second step of the second computer-implemented method for determining the personalized driver parameter set (D) from a pre-recorded set of driving data (RD).

FIG. 7 is a schematic representation of a third step of the second computer-implemented method for determining the personalized driver parameter set (D) from a pre-recorded set of driving data (RD).

### DESCRIPTION

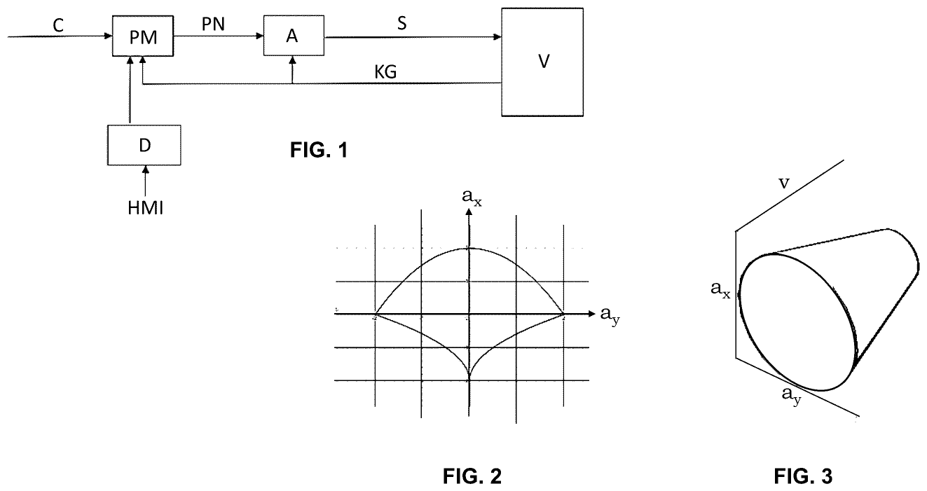

In FIG. 1 a computer-implemented method according to the present disclosure for controlling a vehicle V that is at least partially assisted is schematically illustrated.

The computer-implemented method uses a planner module PM to perform a numerical optimization, wherein context information C, such as route information, road course information and/or environment information, is used as input parameters of the optimization in the planner module PM. The optimization is set up to achieve goals such as a short travel time and low energy consumption. An output of the planner module PM, namely a plan PN, is used as an input parameter for direct ADAS control A for the real movement of the vehicle V. For example, the ADAS control system A generates acceleration, braking and/or steering signals S for the vehicle V. Context and speed information KG are reported back from the vehicle V to the ADAS control system A and the planner module PM.

In accordance with the present disclosure, a personalized driver parameter set D for a specific driver is used as a boundary condition of the optimization in the planner module PM as a further input parameter of the optimization in the planner module PM.

The planner module PM picks up a series of context information C that can contain a variety of signals, such as information about:
the road ahead, for example, curvature, gradient, infrastructure, legal limits, traffic signs, etc.,
the planned macroscopic route,
the environment such as weather, temperature, road conditions, etc.

In some embodiments, traffic information and environmental information are also included, which are collected by any ADAS sensors such as cameras, radar, etc.

An example of a context set C could be, for example:

$$C = \{ v , {a}_{x} , {a}_{y} , c , slope , {v}_{lim} , μ , θ , … \} ,$$

and thus could include, among other things, vehicle velocity v, vehicle longitudinal and lateral acceleration {aₓ, a_{y}}, road curvature c, road gradient slope, maximum allowable speed vₗᵢₘ, road friction u, and road inclination θ.

Based on these inputs, a holistic planning of the vehicle movement in the speed and distance range along the planned route can be carried out. As a result, i.e. as the plan PN, the planning not only provides a speed plan and a path plan, but can also contain signals derived from them, such as acceleration, torque, and steering angle.

Planning is carried out through numerical optimization to ensure the achievement of defined goals and to take into account the desired driving comfort and driver preferences by defining appropriate mathematical constraints. The goals include minimizing travel time and energy consumption. The driver can weigh these goals according to his needs, for example by changing sliders of a human-machine interface HMI and/or activating different driving modes in the vehicle that change the corresponding parameters in the optimization. The numerical optimization problem can be formulated as follows:

$${min}_{u , x} {{\sum }_{k = 0}}^{{N}_{s}} J ( {F}_{1} ( {x}_{k ( s )} , {u}_{k ( s )} ) , {F}_{2} ( {x}_{k ( s )} , {u}_{k ( s )} , P )$$

$$s . t . {x}_{k + 1 ( s )} = f ( {x}_{k ( s )} , {u}_{k ( s )} , V , C )$$

$$\underline{U} \leq {u}_{k ( s )} < \overline{U}$$

$$\underline{X} \leq {u}_{k ( s )} < \overline{X}$$

$${Γ}_{min} ( {x}_{k ( s )} , {u}_{k ( s )} , D , C ) \leq Γ ( {x}_{k ( s )} , {u}_{k ( s )} , C ) \leq {Γ}_{max} ( {x}_{k ( s )} , {u}_{k ( s )} , D , C ) …$$

Where:
J(⋅) is General cost function,
F₁(⋅) is Energy costs,
F₂(⋅) is Travel time costs,
f(⋅) is Vehicle model,
Γₘᵢₙ, Γ, Γₘₐₓ is/are Model of the driver comfort conditions,
V is Vehicle parameter(s), for example, mass, roll and resistance coefficient, frontal area: V={m, cᵣ, c_{d}, A},
D is Driver parameter set (driver comfort conditions),
P is Planner hyperparameter, for example, P={ω_{(c)}} with ω_{(c)} as compensation factor for the personalisation,
C is Context input set, and
U, Ū, X, X is Lower and upper limits for the optimisation variables.

Driver comfort is ensured by the inclusion of a mathematical description

$${Γ}_{min} ( {x}_{k ( s )} , {u}_{k ( s )} , D , C ) \leq Γ ( {x}_{k ( s )} , {u}_{k ( s )} , C ) \leq {Γ}_{max} ( {x}_{k ( s )} , {u}_{k ( s )} , D , C )$$

of the personal driving style, which can be used directly as a secondary condition in the optimization problem. The driver parameter set D describes the individual settings, which can be different for each driver. The specific approach to training and tuning these parameters, along with the planner hyperparameter set P, is described hereinbelow.

The result of the planner is used in an underlying ADAS/AD Controller A, which ensures that the vehicle follows the planned movement in an automated mode. In this way, the planned movement, which has been fully personalized and adapted by the driver, is implemented in the real ADAS/AD vehicle.

### Driver Comfort Constraints Model

An essential element of the present disclosure is the driver comfort conditions, i.e. the driver parameter set in general, in a specific mathematical formulation that can be used directly in a planning module, namely in the optimization of the planner module PM, as a condition for the realization of different driving styles and the corresponding speed trajectory and path trajectory thereof.

The driver constraints are derived for lateral and longitudinal acceleration/deceleration limits and are generally represented by multidimensional closed shapes. This can be formulated mathematically as follows:

$${Γ}_{min} ( {x}_{k ( s )} , {u}_{k ( s )} , D , C ) \leq Γ ( {x}_{k ( s )} , {u}_{k ( s )} , C ) \leq {Γ}_{max} ( {x}_{k ( s )} , {u}_{k ( s )} , D , C )$$

Examples of the comfort conditions, the driver parameter set D and the context C:

$$D = \{ p , q , {a}_{x , min} , {a}_{x , max} , {a}_{y , min} , {a}_{y , max} \} ,$$

$$C = \{ v , {a}_{x} , {a}_{y} , c , slope , {v}_{lim} , μ , θ , … \}$$

wherein the values in D refer to the mathematical formulation of the conditions.

For example, should one not consider dependencies on the context (C={ }) and define the driver conditions Γₘᵢₙ and Γₘₐₓ by (half) astroid equations and (half) circle equations in the acceleration domain and with the following driver parameter set,

$$D = \{ p := 0.5 , q := 2 , {a}_{x , min} := 2 , {a}_{x , max} := 2 , {a}_{y , min} := 2 , {a}_{y , max} := 2 \}$$

the driver conditions could look like this

$$- 2 \cdot ( 1 - {\vert \frac{{a}_{y}}{2} \vert}^{0.5} ) \leq {a}_{x} \leq 2 \cdot ( 1 - {\vert \frac{{a}_{y}}{2} \vert}^{2} )$$

which can be graphically represented as shown in FIG. 2.

For the context set comprising of the speed of the vehicle, C={v}, and for

$$D = \{ p := 0.5 , q := 2 , {a}_{x , min} ( v ) , {a}_{x , max} ( v ) , {a}_{y , min} ( v ) , {a}_{y , max} ( v ) \}$$

the driver conditions can look like those shown in FIG. 3.

### Data-Driven Model Adjustment of Driver Comfort Conditions (Constraint Fitting)

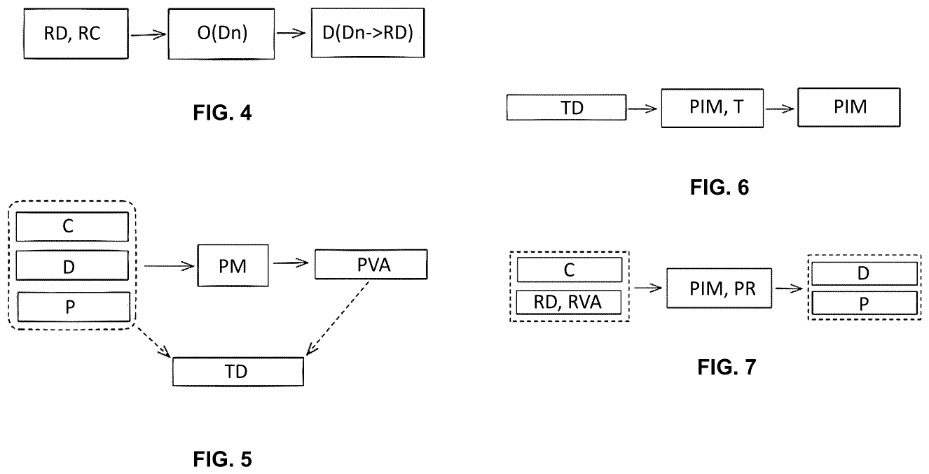

This section describes the process of model adaptation (fitting) of the mathematical model of the driver's comfort conditions, as shown in FIG. 4:

$${Γ}_{min / max} ( {x}_{k ( s )} , {u}_{k ( s )} , D , C )$$

to a previously recorded set of driving data RD, in which checking a calibration data record is carried out RC by determining a suitable driver parameter set D. Since the set of driving data RD is recorded by a fully human-controlled calibration drive and thus implicitly reflects the driver's preferences, we consider this phase of the workflow to be data-driven personalization.

The optimization process O itself is based on a mathematical optimization goal that measures how well a given driver-friendly constraint Dn, for example, the previously mentioned shape in the acceleration range defined by its parameterization, see FIGS. 2 and 3, can represent and explain the recorded data samples RD. In light of this optimization goal, we perform numerical optimization of the parameterization to maximize the agreement between the model of the driver constraint Dn and the recorded data samples RD.

Since a mathematical formulation of the optimization goal is preferably fully differentiable, it is compatible with a variety of optimization algorithms, ranging from a simple lattice search to optimizers based on stochastic gradient descent.

Once the optimization phase converges, the resulting data-driven parameterization Dn is used as a configuration input D for the planner.

### Learning and Predicting Driver Comfort Limitations

With reference to FIGS. 5 to 7, a complementary system for deriving driver comfort conditions from recorded test drives available as speed and acceleration data is described below. This system is based on the pre-training of a machine learning model.

### Step 1 (Offline Step): Building a Synthetic Pre-Training Dataset (See FIG. 5):

From a number of different route layouts, sections are first randomly selected. For each of these sections, we then run the planner PM with driver parameters D, context C and planner hyperparameters P, which are also randomly selected. The overall result of this step is a diverse dataset that includes the following elements: {(D, C, P, planned speed and acceleration)}. The planned speed and acceleration are shown in FIG. 5 as PVA. The dataset determined by this is referred to as the training dataset TD.

### Step 2 (Offline Step): Training the Machine Learning Model (See FIG. 6):

Starting from the dataset TD created in step 1, we train T (Training) a machine learning model, namely a planner-inversion model PIM, which, given context C and planned speed and acceleration PVA data as input, predicts (PR Predict) the underlying comfort conditions D for the driver and the corresponding hyperparameters P of the planner (see FIG. 7).

f(C, Planned Speed and Acceleration)->(D, P)

It is therefore basically trained to predict an inversion of the planning module PM (PM⁻¹. referred to above as f)—in FIG. 7 in the step PIM, PR.

### Step 3 (Online Step): Model-Based Personalization Through Machine Learning (See FIG. 7):

This step describes a finer alternative to the constraint fitting approach described above (FIG. 4). Given the planner inversion model PIM (or f) and the speed and acceleration records from a calibration test drive including the corresponding context C, we use PIM to predict the most likely non-derivable parameterization of the planner (driver parameter D and planner hyperparameter P). In this case, since the input data for the model are not the result of a synthetic data generation process, but an actual user record (driver) from a calibration drive, it is an alternative personalization method.

The terms “coupled,” “attached,” or “connected” may be used herein to refer to any type of relationship, direct or indirect, between the components in question, and may apply to electrical, mechanical, fluid, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

A ADAS control system
a_{x,max}, a_{x,min} Acceleration limits (longitudinal)
a_{y,max}, a_{y,min} Acceleration limits (lateral)
C Context Information
D Driver parameter set
Dn Different driver parameter sets
HMI Human Machine Interface, User Interface
KG Context and speed information
LM Planner inversion model
O Optimisation method
P Planner hyperparameter
PM Planner module
PN Plan
PR Prediction
PVA Planned speed and acceleration
RC Checking a calibration data set
RD Set of driving data
RVA Recorded speed and acceleration
S Acceleration, braking and/or steering signals
T Training
TD Training dataset
V Vehicle
V Speed
Γ Driver comfort conditions model

What is claimed is:

1. A computer-implemented method for controlling a vehicle that is at least partially assisted via an Advanced Driving Assistant Systems (ADAS) control system, the computer-implemented method comprising:
reducing travel time and energy consumption by conducting, by a planner module, numerical optimization based on first input parameters that includes route information, road course information and/or environmental information;
receiving a personalized driver parameter set corresponding to a personal driving style, and applying the personalized driver parameter set as a boundary condition for the numerical optimization; and
operating the vehicle by transmitting, by the planner module after the numerical optimization, second input parameters to the ADAS control system.

2. The computer-implemented method of claim 1, further comprising determining the personalized driver parameter set by model adaptation.

3. The computer-implemented method of claim 1, further comprising determining the personalized driver parameter set by learning from a pre-recorded set of driving data.

4. The computer-implemented method of claim 1, further comprising determining the personalized driver parameter set from the pre-recorded set of driving data by model adaptation via an optimization algorithm.

5. The computer-implemented method of claim 4, wherein the optimization algorithm calculates, for different driver parameter sets, the approximation of a set of driving data calculated from the driver parameter sets to the pre-recorded set of driving data.

6. The computer-implemented method of claim 1, further comprising determining the personalized driver parameter set by a machine learning model from a recorded set of driving data associated with at least one trip by the vehicle.

7. The computer-implemented method of claim 6, wherein the machine learning model is trained using a training data set for different driving routes, with different context information and different models of personalized driver parameter sets.

8. The computer-implemented method of claim 7, further comprising using the training data set to train a planner inversion model.

9. The computer-implemented method of claim 8, further comprising determining, by the trained planner inversion model, the personalized driver parameter set from the pre-recorded set of driving data.

10. The computer-implemented method of claim 1, further comprising determining the personalized driver parameter by artificial intelligence from a recorded set of driving data associated with at least one trip by the vehicle.

11. The computer-implemented method of claim 1, wherein the first input parameters further includes one or more of speed limits, traffic signs, environmental information, road condition information, traffic information, and sensor information.

12. The computer-implemented method of claim 11, wherein the road course information includes curves and gradients.

13. The computer-implemented method of claim 11, wherein the environmental information includes weather information and temperature information.

14. The computer-implemented method of claim 11, wherein the sensor information includes information about vehicles in a surrounding area.

15. The computer-implemented method of claim 11, wherein the sensor information includes road conditions in the surrounding area.

16. The computer-implemented method of claim 1, wherein the personal driving style is represented by lateral acceleration limits and longitudinal acceleration limits in the personalized driver parameter set.

17. The computer-implemented method of claim 1, wherein the personal driving style is represented by lateral acceleration limits in the personalized driver parameter set.

18. The computer-implemented method of claim 1, wherein the personal driving style is represented by longitudinal acceleration limits in the personalized driver parameter set.

19. A computer-implemented method for operating an Advanced Driving Assistant Systems (ADAS)-controlled vehicle, the computer-implemented method comprising:
conducting numerical optimization based on first input parameters that includes route information, road course information, and/or environmental information;
receiving a personalized driver parameter set corresponding to a personal driving style;
applying the personalized driver parameter set as a boundary condition for the numerical optimization; and
operating the vehicle by transmitting, by the planner module after the numerical optimization, second input parameters to the ADAS control system.

20. A control unit for an at least partially assisted vehicle, the control unit implementing the computer-implemented method of claim 1.
